(19) United States
(12) Patent Application Publication
(10) Pub. No.: US 2004/0034553 A1
(43) Pub. Date: Feb. 19, 2004

(54) Method and system for prioritizing business processes in a service provisioning model

(75) Inventors: David W. Cole, Austin, TX (US); George A. Geno JR., Wildwood, MO (US); Tedrick N. Northway, Wood River, IL (US); Paul D. Peterson, Round Rock, TX (US); Chris E. Terry, Round Rock, TX (US)

Correspondence Address: Frank C. Nicholas, CARDINAL LAW GROUP, Suite 2000, 1603 Orrington Avenue, Evanston, IL, 60201, US

(73) Assignee: International Business Machines Corporation, Armonk, NY (US)

(21) Appl. No.: 10/219,697

(22) Filed: Aug. 15, 2002

(51) Int. Cl. G06F 17/60

(52) U.S. Cl. 705/7

(57) ABSTRACT

A method of prioritizing a business process based on enabling components is provided. The enabling components may comprise technology, staff, processes or other tools. The plurality of service elements used to accomplish the business process are determined. A criticality value for a first service element of the business process is determined, as well as a timing value for the first service element of the business process. A first implementation Value is calculated based on the criticality value and the timing value. The first service element is then ranked in a hierarchy based on the first implementation value. Computer program product and systems using the method are also provided.

### BACKGROUND OF THE INVENTION

1. Field of the Invention

The present invention relates generally to business systems, and more particularly, to a system and method for provisioning services by evaluating components that enable the services and prioritizing the processes that provide the services based on the evaluation.

2. Description of Related Art

Currently, companies have “business processes” that are enabled by multiple, generally heterogeneous, technology components. In addition, a particular business process may span multiple lines of business internally and externally. Thus, the enabling technology components are generally of disparate types and are managed by disparate groups.

For example, a typical loan process may be enabled by the following technology components: several different software applications, several disparate databases, a LAN network, a WAN network, one or more servers and several clients which may vary in type, such as desktops and laptops, or brand. In such a typical process, a technology support group would be available for each application, another group for the LAN component, yet another support group for the WAN component, a support group for the server, and at least one more support group for the clients. Each support group has a focused view on its particular technology component but typically no one group has the overall business process view. That is, no one support group has the ability to view each of the technology component groupings (sometimes called “towers”) in the context of a whole, consolidated business process. Thus, it is often difficult to determine the real or potential impact (the business view) of an incident that has occurred at the component level.

Generally, an end-user sees the business impact of an incident and communicates this impact to the technician but the user does not necessarily have nor require the understanding of the technology component involved with the incident. From the other view, a technician understands the incident that has occurred at the level of the technology component but the technician does not necessarily see the business impact of the incident. This disparity is particularly apparent when an outsourcing organization provides the technology component.

One traditional approach to coordinate disparate technology components uses custom gateway or interface systems. These gateways are not generally designed to integrate data exchange between large numbers of different systems and applications. Furthermore, these gateways are not designed to integrate the technological components with end-service business processes, i.e. each gateway is not aware that it is part of a higher-level business process.

Other approaches for coordinating disparate technology components are to monitor the types of transactions between different systems and applications. These transaction monitors tend to use rigorous rules to force integrated data exchange between different systems and applications. Also, these monitors are not designed to integrate the technological components with end service business processes. Although transaction monitors are able to monitor specific transactions, they are unable to gauge the overall “timing”, of the business process in terms of performance, availability and/or capacity of the system.

The above approaches do not provide a business system that integrates both business and technology components as if the technology components are a single application directly aligned to the metrics of a business process.

The above approaches do not provide a business system that includes integrated underlying technology that is able to reflect the end-user experience of the system.

In addition, the above approaches do not integrate technology components in a manner that reflects the business view of the customer.

Furthermore, the above approaches do not evaluate the enabling components in terms of the overall business process and then prioritize the service elements that will accomplish the overall business process based on the evaluation of the enabling components.

It would be desirable therefore to provide a method and system of service provisioning that overcomes the above.

### SUMMARY OF THE INVENTION

One aspect of the present invention provides a method of prioritizing a business process based on enabling components. The plurality of service elements used to deliver the business process is determined. A criticality value for a first service element of the business process is determined, as well as a timing value. A first implementation value is calculated based on the criticality value and the timing value. The first service element is then ranked in a hierarchy based on the first implementation value.

Another aspect of the present invention provides computer program product for prioritizing a business process based on enabling components. The product includes means for determining a plurality of service elements to be delivered during the business process. The product also includes means for determining a criticality value and a timing value for a first service element of the business process. The product further includes means for calculating a first implementation value based on the criticality value and the timing value and means for ranking the first service element in a hierarchy based on the first implementation value.

Yet another aspect of the present invention provides a system for prioritizing a business process based on enabling components. The system includes means for determining a plurality of service elements to be delivered during the business process. The system also includes means for determining a criticality value and a timing value for a first service element of the business process. The system further includes means for calculating a first implementation value based on the criticality value and the timing value and means for ranking the first service element in a hierarchy based on the first implementation value.

The foregoing, and other, features and advantages of the invention will become further apparent from the following detailed description of the presently preferred embodiments, read in conjunction with the accompanying drawings. The detailed description and drawings are merely illustrative of the invention rather than limiting, the scope of the invention being defined by the appended claims in equivalence thereof.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a schematic diagram of one embodiment of a service-prioritizing system in accordance with the present invention;

FIG. 2 is a flow diagram of one embodiment of a method of prioritizing service elements in accordance with the present invention;

FIG. 3 is a schematic diagram of one embodiment of a priority matrix in accordance with the present invention;

FIG. 4 is a schematic diagram of another embodiment of a priority matrix in accordance with the present invention;

FIG. 5 is a schematic diagram of one application of the method of FIG. 2 in accordance with the present invention;

FIG. 6 is a schematic diagram of another application of the method of FIG. 2 in accordance with the present invention;

FIG. 7 is a block diagram of one embodiment of a technology component in accordance with the present invention; and

FIG. 8 is a block diagram of another embodiment of a technology component in accordance with the present invention.

### DETAILED DESCRIPTION OF THE PRESENTLY PREFERRED EMBODIMENTS

Businesses have numerous critical processes, which are enabled by multiple, disparate technologies. In today's IT environment, there is often a support group for each type of technology, each with its own “tower” management platform. In addition, each group has its own management tools typically focused on monitoring a specific subsystem or element within the IT infrastructure, with little or no capability to evaluate how that component actually impacts the business process from an end-to-end perspective, or how the aggregate performance of all the technology components interacting together as a whole are impacting the business process. Because the systems management towers are often very disjointed, complex problems among many interrelated heterogeneous technology components may be difficult to quickly identify, may lead to multiple support personnel being needlessly dispatched, and may have no business impact context. This is particularly evident in the current event management and business process “view” tools which only consider the “IT severity” of an event as opposed to mapping a particular anomaly to an actual business impact. The following example will help illustrate this concept.

One server must communicate to another server, via a network router, in order to complete a particular business transaction, such as, for example, inventory management. If the network failed, or went down, from an IT, perspective the network event generated by this failure might be “fatal” or completely down. At the network support layer this IT component failure would trigger immediate support attention. However, at the business process layer, the network failure is only “fatal” or fully down if there is a current request for these two systems to communicate, i.e., if the inventory management service element is required. If no one needs the business service element at the point of failure then the fact that a network is down is important, but to the business, it is transparent. At the event level of the network failure there is no intelligence to determine whether or not the business process has actually been impacted and will always show “fatal” when it goes down. This means that each IT event must be mapped to a business impact within the context of the business process.

The present invention enables this mapping of IT severity to business impact severity. Using the above as an example, the priority of the “Inventory Management” service element is evaluated in relation to the priority of other service elements. Resources may then be assigned to the service elements based on the determined ranking or procedures may be carried out based on the determined ranking.

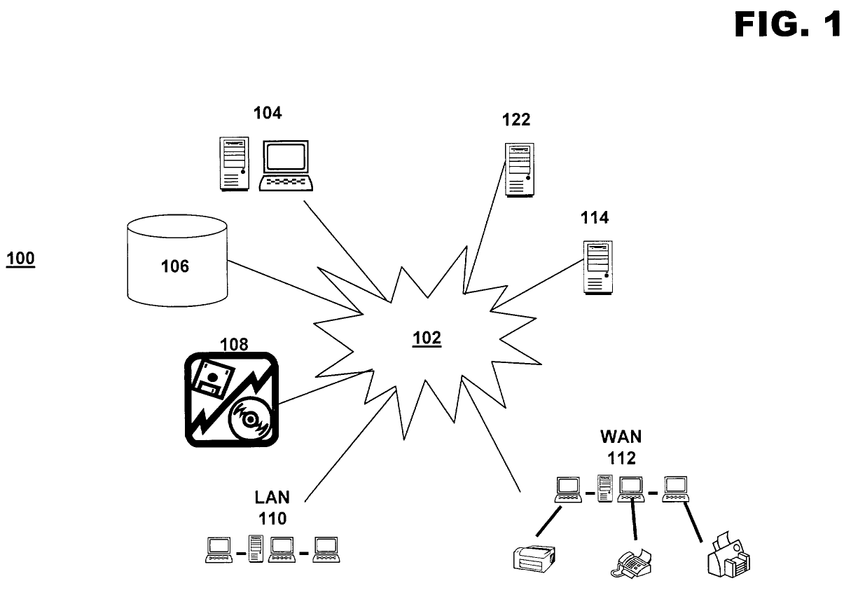

FIG. 1 shows one embodiment of a system of integrated business applications and technology components at 100. System 100 is a system of technology components in which the present invention may be implemented. Each of the technology components provides one or more service elements. These service elements are elements of the overall business service process to be provided. The term “service elements”, therefore, includes services, processes, subprocesses and activities that are elements of the overall business process being provided.

System 100 includes a service-prioritizing matrix 122, which provides integration between various technology components and business processes connected together within system 100. Service prioritizing matrix 122 may be, for example, hardware or software components that are capable of determining service element priorities based on input from other components of system 100. For example, service prioritizing matrix 122 may comprise a customized server with software that receives and processes input describing criticality and timing values of various service elements in a given overall business process.

Matrix 122 may further include connections such as wire, wireless communication links or fiber optic cables for connecting the various technology components and processes and for transmitting matrix calculations to the technology components of system 100.

System 100 may also include a variety of technology components that may be used to accomplish service elements that have been prioritized by matrix 122. For example, FIG. 1 shows an independent client 104, a database 106, software applications 108, a local area network (LAN) 110 and a wide area network (WAN) 112.

In addition, system 100 may include a service-provisioning model 102 which may be used to implement the values calculated by matrix 122 and to deploy the various technology components of system 100. One such service-provisioning model is described in related U.S. application Ser. No.______ (Attorney Docket No. AUS9-2002-0230-US1), herein incorporated by reference. Alternatively, any suitable service provisioner that is capable of translating the prioritized values of matrix 122 to technology components or enabling components may be used.

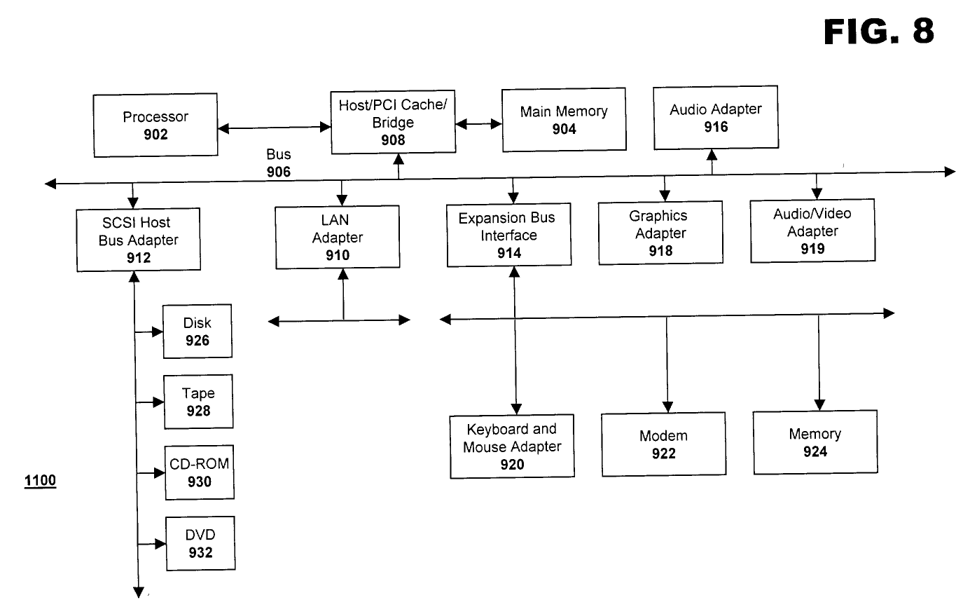

Independent client 104 may be, for example, a data processing system as described in detail below in FIG. 8. Independent client 104 may be a technology component that is capable of providing services to one or more geographic locations based on customer specific priority requirements. Service elements accomplished by independent client 104 are evaluated and prioritized by matrix 122 within the context of the overall business process.

Database 106 may be, for example a suitable database for storing data as is well known in the art. Database 106 may be a technology component that is capable of storing information to be retrieved at one or more geographic locations based on customer specific priority requirements. Service elements accomplished by database 106 are evaluated and prioritized by matrix 122 within the context of the overall business process.

Software applications 108 may be, for example, any suitable applications that are capable of accomplishing the objectives of the overall business process being evaluated by matrix 122. The rank of software applications prioritized by matrix 122 will depend on the overall business process being evaluated. For example, when evaluating an overall billing process, matrix 122 may assign a fairly high rank to service elements involving accounting software but, when evaluating an overall server install process, the service elements accomplished by the same accounting software may be assigned a fairly low rank. Service elements accomplished by software 108 are evaluated and prioritized by matrix 122 within the context of the overall business process.

Local area network (LAN) 110 may be for example a LAN as is well known in the art, which is capable of providing services to one or more geographic locations based on customer specific priority requirements. Service elements accomplished by LAN 110 are evaluated and prioritized by matrix 122 within the context of the overall business process.

Wide area network (WAN) 112 may be for example a WAN as is well known in the art, which is capable of providing services to one or more geographic locations based on customer specific priority requirements. Service elements accomplished by WAN 112 are evaluated and prioritized by matrix 122 within the context of the overall business process.

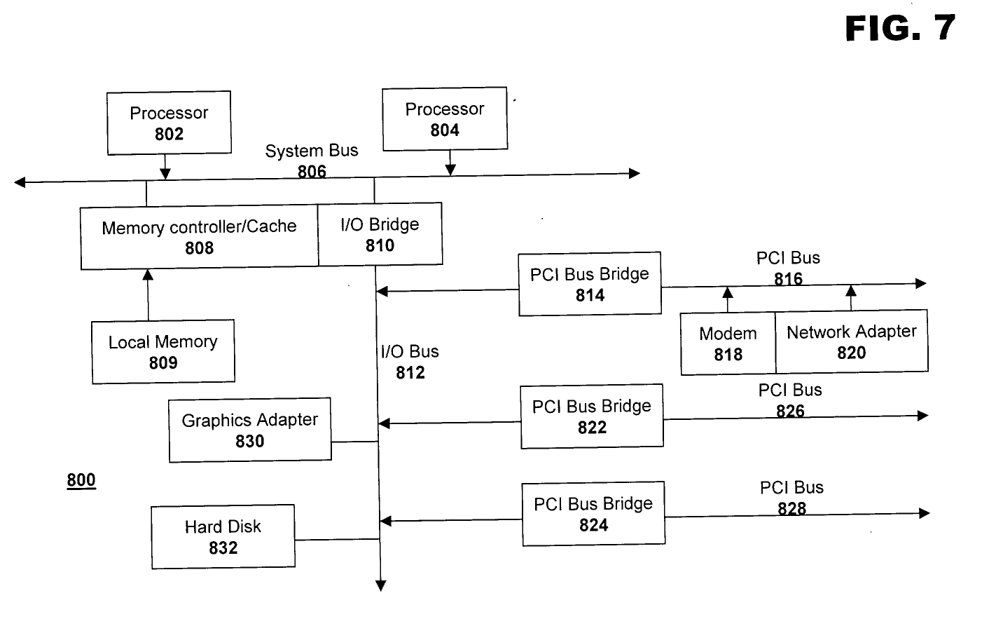

Server 114 may be, for example, a data processing system as described in detail below in FIG. 7. Server 114 may be a technology component that is capable of providing services to one or more geographic locations based on customer specific priority requirements. Service elements accomplished by server 114 are evaluated and prioritized by matrix 122 within the context of the overall business process.

Matrix 122 may prioritize an overall business process that utilizes all of the components 104, 106, 108, 110, 112, 114. In addition, the service elements prioritized by matrix 122 may include services, processes, subprocesses and activities that are accomplished by any suitable combination of components 104, 106, 108, 110, 112, 114.

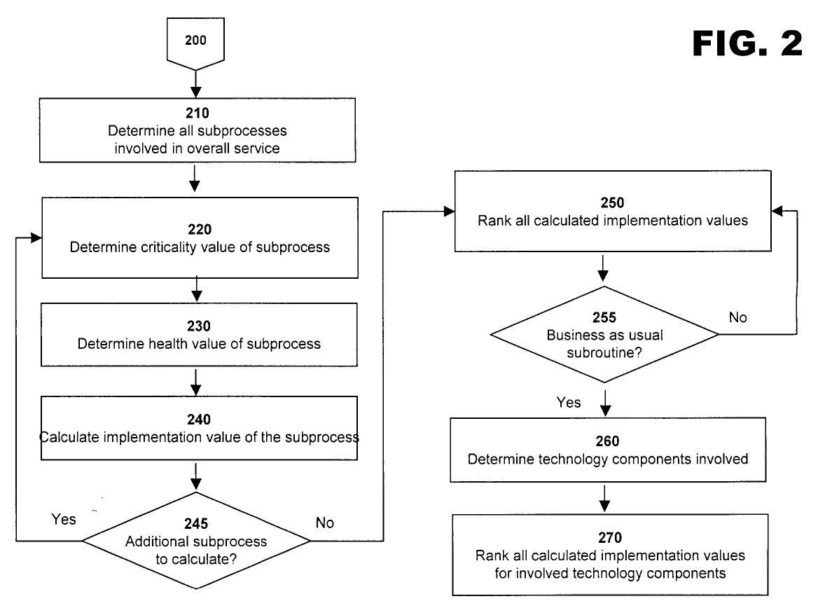

FIG. 2 shows a flow diagram of one embodiment of a method of prioritizing service elements in a service-provisioning model in accordance with the present invention at 200.

In one embodiment of the invention, the method of FIG. 2 is administered by one or more multiple software programs or applications on or in association with matrix 122.

As seen at block 210, the scope of overall service is determined and validated. This may be done for example, in consultation with the customer, by generating a letter of intent that describes the scope of the service or by generating a database, table or spreadsheet that describes the overall business process. In one embodiment of the invention, the description of the overall business process is input into a pre-designed template that is customized to generate data for the service-prioritizing matrix 122. Typically, the scope of overall service is described by determining one or more steps to the overall process or by determining one or more service elements that make up the business process (e.g., one or more services, processes, subprocesses or activities that are a part of the business process).

As seen at block 220, each service element is assigned a Criticality Value. This Criticality Value may be determined for example in consultation with the customer or by generating a database, table or spreadsheet that determines the Criticality Value. In one embodiment of the invention, the description of the Criticality Value is input into a pre-designed template that is customized to generate data for the service-prioritizing matrix 122.

The Criticality Value indicates how critical the successful delivery of the service element is to the overall business process. For example, in an overall business process of “Billing”, the service element of “Creating the Invoice” may be assigned a high success factor, indicating that the element of “Creating the Invoice” is extremely critical to the success of the overall “Billing” process. Thus, if the failure of one specific service element will absolutely guarantee that the overall business process fails or struggles, then the priority of that service will be high. Two examples of key elements that may be considered in determining Criticality Value include customer satisfaction with the overall business process (i.e., what service elements generate the most customer satisfaction when accomplished) and profit (i.e., what service elements generate the most revenue when accomplished). The Criticality Value may be based upon the need for a service element to succeed for both the customer and the service provisioner.

The Criticality Value may be rendered as any suitable value, such as, for example, a numerical value. In one embodiment of the invention, the Criticality Value may be a number from “1” to “9” with “9” indicating the most critical service elements. In order to further aid matrix 122 in prioritizing the service elements, the number of service elements to be assigned a particular Criticality Value may be limited. For example, based on the overall business service to be provided, the number of “9”s that may be assigned may be limited to two service elements whereas an unlimited number of service elements may be assigned a “1” Criticality Value.

Alternatively, the Criticality Value may be a number from “1” to “9” with “1” indicating the most critical service elements. In some embodiments of the invention, a plurality of service elements may be assigned the same Criticality Value. Thus, the Criticality Value may be a simple ordering of value and may not indicate relative value. That is, no effort is made to equate or rationalize the differences between the multiple Criticality Values. For example, the difference between a Criticality of “1” and “2” may in fact be very small; perhaps only slightly as small as the difference between “1” and “3”. In another instance, the difference between “1” and “2” may, in fact, be very much smaller or larger than the singular difference between “5” and “6”.

In some embodiments of the invention, a Nonessential Value may be assigned. This Nonessential Value may indicate a service element that is outside the scope of the overall business process, while the remaining values are used to assign Criticality Values as described above. For example, a “1” may be assigned to any service element that is not within the scope of the overall business process and is thus not at all critical to the success of the overall business process. Meanwhile, values from 2 to 9 are assigned as Criticality Values in order to describe criticality of service elements that are involved in the overall business process.

As seen at block 230, each service element is then assigned a Timing Value. This Timing Value may be determined for example in consultation with the customer or by generating a database, table or spreadsheet that determines the Timing Value. In one embodiment of the invention, the Timing Value is input into a pre-designed template that is customized to generate data for the service-prioritizing matrix 122.

The Timing Value may be based on the current health of a given service element. In other words, the Timing Value indicates how adequately the service element is currently being delivered to the customer. For example, the Timing Value may be a number from “1” to “100” with “1” indicating the service elements that are currently being least adequately delivered. The Timing Value may also indicate the dependence of other service elements on the success of this service. For example, the Timing Value may be a number from “1” to “100” with “1” indicating the service elements that must be delivered as soon as possible in order for other service elements to follow. The Timing Value may also indicate the customer's demand for the service element. For example, the Timing Value may be a number from “1” to “100” with “1” indicating the service elements that must be delivered as soon as possible in order to receive high customer satisfaction. The Timing Value may be based upon the urgency for a given service element to be fully operational. The Timing Value may reflect that a given service element needs to be placed into operation without delay, perhaps with temporary measures in place to deliver it.

In some embodiments of the invention, a plurality of service elements may be assigned the same Timing Value. Thus, the Timing Value may be a simple ordering of value and may not indicate relative value. That is, no effort is made to equate or rationalize the differences between the multiple Timing Values.

In order to further aid matrix 122 in prioritizing the service elements, the number of service elements to be assigned a particular Timing Value may be limited. For example, based on the overall business process, the number of “1”s that may be assigned may be limited to 2 whereas an unlimited number of service elements may be assigned a “100” Timing Value.

As seen at block 240, an Implementation Value is determined which reflects both the Criticality Value and the Timing Value of a given service element. The present invention provides a means for correlating the business impact of a service element to the enabling components used to deliver a given service element. The Criticality Value describes the business severity of a given service element in the context of the overall business process. Meanwhile, the Timing Value evaluates the ability of the enabling components to deliver the same service element, also within the context of the overall business process. The Implementation Value may be determined using any suitable algorithm or other method of calculation.

The Implementation Value algorithm may also take into account other variables in addition to Timing and Criticality. For example, the algorithm may use a Health Variable, which reflects the current health of the service element as described above. This Health Variable may be the same as the Timing Value or may be a component of the Timing Value.

The Implementation Value algorithm may also use a Call Priority Variable, which reflects the relationships between a given service element and other service elements. For example, a service element such as “Installing Accounting Software” may be called upon by more than one other service element such as “Configuring a Client” and “Configuring a Server”. For the service element of “Installing Accounting Software”, a call from the “Configuring a Server” service element may be assigned a different Call Priority Variable than a call from the “Configuring a Client” service element, thereby affecting the Implementation Value of the “Installing Accounting Software” service element.

The algorithm may also use an Answer Priority Variable, which reflects the relationships between a given service element and other service elements. For example, a service element such as “Searching Inventory” may receive answers from more than one other service element such as “Generating Current Inventory Report” and “Generating Latest Items Purchased Report”. For the service element of “Searching Inventory”, a response from the “Generating Current Inventory Report” service element may be assigned a different Answer Priority Variable than a response from the “Generating Latest Items Purchased Report” service element, thereby affecting the Implementation Value of the “Searching Inventory” service element.

In some embodiments of the invention, the Call Priority Variables and the Answer Priority Variables are predefined as part of defining the scope of the overall service at block 210.

As seen at block 245, matrix 122 then determines if there are additional service elements for which an Implementation Value should be determined. If there are additional service elements within the overall business process, the routine returns to block 220, where the next service element is assigned a Criticality Value and continues to block 230 where the next service element is assigned a Timing Value and finally to block 240 where the Implementation Value is calculated for the next service element. This continues until it is determined at block 245 that there are no further service elements to be evaluated.

If there are no further service elements to be evaluated, the routine continues to block 250 where the calculated Implementation Values are ranked in priority within the context of the overall business process.

In one embodiment of the invention, once the matrix determines the ranking and priorities of the Implementation Values, one or more technology components maybe used to carry out the service elements based on their ranking. For example, service-provisioning model 102 may be used to implement the service elements based on the values calculated by matrix 122. One such service-provisioning model is described in related U.S. application Ser. No._______ (Attorney Docket No. AUS9-2002-0230-US1), herein incorporated by reference. Service provisioning model 102 may use one or more technology components of system 100 to carry out the service elements prioritized by matrix 122.

As seen at block 255, some embodiments of the invention may also comprise an optional subroutine such as those shown at blocks 260 and 270. In these embodiments, a preliminary ranking is determined at block 250 based on the overall business process. During operation of the overall business process (e.g., during “Business as Usual”), the technology components involved may be deployed according to the priorities generated by matrix 122. At block 260, matrix 122 receives input from the technology components involved as they are used to implement various service elements. If the actual implementation affects the performance or relationships of a particular technology component, the service elements accomplished by the component will require changes in Criticality Values or Timing Values or other variables as described above. Based on the technology components involved, another ranking, or another Implementation Value may be generated by matrix 122 at block 270.

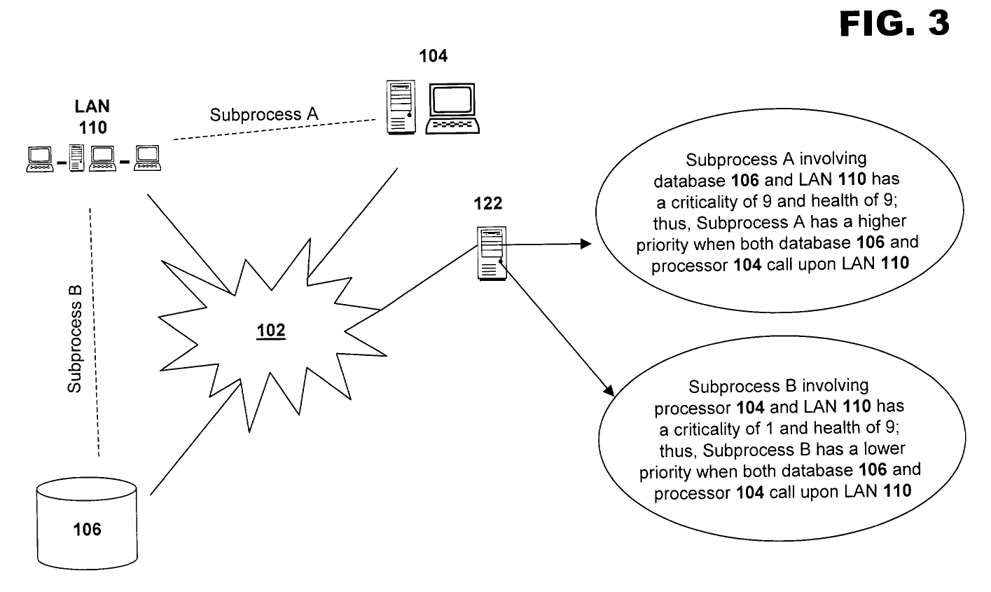

FIG. 3 further illustrates one application of the service prioritizing subroutine described at blocks 260, 270.

As seen in FIG. 3, the service prioritizing method and system may be used to analyze service elements of an overall business process (e.g. processes, subprocesses, activities and procedures) and to determine the priorities of the service elements in relation to the overall business process. For example, the overall business service may be a “Provisioning/Billing” service managed by service-provisioning model 102. In the example of FIG. 3, client 104 is a personal computer, which receives orders from one geographic location while database 106 is the inventory database. LAN 110 communicates with and is involved in service elements with both client 104 and database 106. Prioritizing matrix 122 prioritizes the processes that involve client 104 and database 106, as well as LAN 110. To take the simplest example, at blocks 210 through 245, the Criticality Value of service element A is determined to be 9 and its timing value is determined to be 1, resulting in an Implementation Value of 10. Then repeating the method, the Criticality Value of service element B is determined to be 2 and its timing value is determined to be 9, resulting in an Implementation Value of 11.

At blocks 255 through 270, the overall business process is allowed to run using components client 104, database 106 and LAN 110. Database 106 is involved in only one process, service element A, which also involves LAN 110. Meanwhile, client 104 is involved in only one process, service element B, which also involves LAN 110. Thus, in a situation where both client 104 and database 106 call on LAN 110, service prioritizing matrix 122 gives a priority to the service element which uses database 106 (service element A) over the service element which uses client 104 (service element B). In accordance with the present invention, once service element A and service element B have been allowed to run during “Business as Usual”, the two elements may be re-evaluated to determine if a change in Criticality or Timing Values is required for either service element A or B. On the other hand, “Business as Usual” may confirm that the relationship of service element A to service element B should remain as originally ranked at block 210.

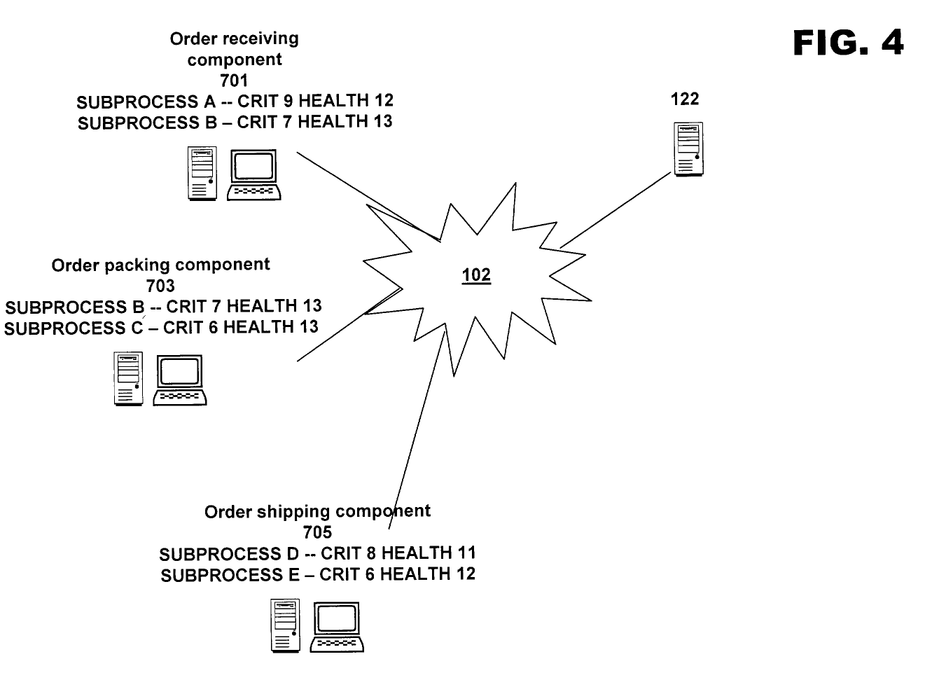

FIG. 4 further illustrates one application of the service-prioritizing method described in FIG. 2.

In the example of FIG. 4, technological components 701, 703 and 705 are three separate servers, each of which manages a different service element of the overall business process of IT “Order Fulfillment”. Server 701 implements the “IMAC” service element (which manages Installing, Moving, Adding, Changing processes), server 703 implements the “Supporting Deskside” service element (which manages deskside support processes), and server 705 implements the “Managing Inventory” service element (which manages inventory and assets).

In this slightly more complex example, servers 701, 703 and 705 all communicate with each other and work together to deliver five different service elements A, B, C, D, and E. Prioritizing matrix 122 determines the service elements that involve all three of the servers 701, 703, 705. To take the simplest example, order receiving server 701 is involved in two service elements (service element A and service element B), order packing server 703 is involved in two service elements (service element C and, like server 701, service element B) and order packing component 705 is involved in two more service elements (service element D and service element E).

Table A below shows the Criticality and Timing Values and a simplified Implementation Value for each service element.

TABLE A

| Service | Criticality | Timing | Implementation |
|---|---|---|---|
| element | Value | Value | Value |
| A | 9 | 5 | 14 |
| B | 8 | 1 | 9 |
| C | 7 | 5 | 12 |
| D | 8 | 4 | 12 |
| E | 1 | 16 | 17 |

Based on these Implementation Values, it can be seen that, in the context of the overall business process, service element A is the most critical service element (Criticality Value=9). However, because the overall business process uses both servers 701 and 703, the Timing Value of service element B is of high importance. Thus, service element B turns out to be the first service element to be implemented (Implementation Value=9) even though its Criticality Value is only 8. This is because in the context of the overall business process, service element B has a higher ranking Implementation Value because more than one service element and more than one enabling component relies on its delivery.

Meanwhile, although service elements C and D have different criticality values (service element C criticality value=7 and service element D criticality value=8) and are implemented on two different servers, they reflect the same Implementation Value and thus have the same priority in terms of the overall business process. In accordance with the present invention, service-prioritizing matrix 122 will rarely generate the same Implementation Value for two service elements, due to the influence of such variables as Call Priority Variable and Answer Priority Variable. In the case where two elements do share the same Implementation Value, once “Business as Usual” is run with the enabling components (blocks 260, 270 of the method of FIG. 2), the ranking is typically re-assigned so that the two service elements no longer have the same Implementation Value. Thus, in the above table, once components which enable service element C and service element D have been allowed to interact, service element D's Timing Value may be changed to 3 (New Implementation Value=11) while service element C's Timing Value is changed to 5 (New Implementation Value=13), which will result in corresponding deployment changes.

Furthermore, although service element A and service element C have the same timing value (5), service element C's Implementation Value indicates that service element C has a higher priority in terms of the overall business process than service element A does. Finally, although service Element E has an Implementation Value of 17, its Criticality Value of 1 indicates that service element E has no part in the overall business process of “Order Fulfillment”.

In one embodiment of the invention, once the priority is determined by matrix 122, the technological components may be deployed to accomplish the process by service provisioning model 102.

The Implementation Values for processes, subprocesses, activities and procedures that rely on order receiving component 701 will reflect that service element B is a critical risk area to the overall business process. Because service-prioritizing matrix 122 evaluates all service elements, each component may be made aware of exactly how important each service element is to the overall business process. In addition, the Implementation Values assigned to various processes can indicate that problems with server 701 (involved in two highly prioritized processes) must always be resolved before problems with server 705 (involved in two lower priority processes). Because the Implementation Values are assigned based on the overall business process, even if server 705 is a larger or more complicated server, the Implementation Values indicate that the priority server in terms of the overall business process is server 701.

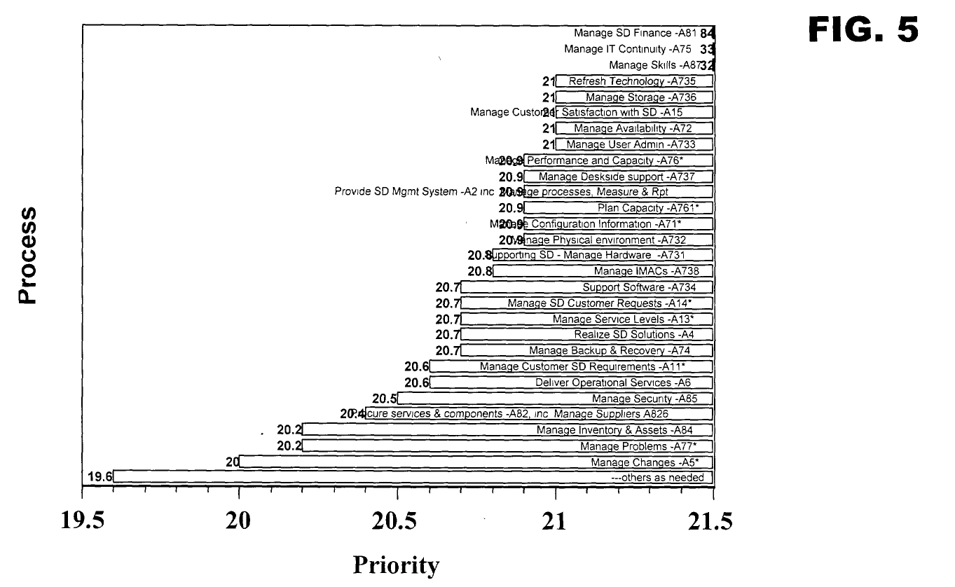

FIG. 5 shows a diagrammatic representation of one embodiment of a priority matrix for evaluating service elements accomplished by one or more component.

As seen in FIG. 5, the overall business process of “Managing Finance” is evaluated using matrix 122. This evaluation includes determining all the service elements involved in the overall business process. For each service element, a determination is then made of the Criticality Value of the service element and of the Timing Value of the service element. The Criticality and Timing Values are used by matrix 122 to determine the ranking of the service element in the context of the overall business process.

Thus the service element of “Refreshing Technology” is as much of a priority to the overall business process as the service element of “Managing Storage.” However, “Managing Storage” is more of a priority to the overall business process than “Managing Performance and Capacity.”

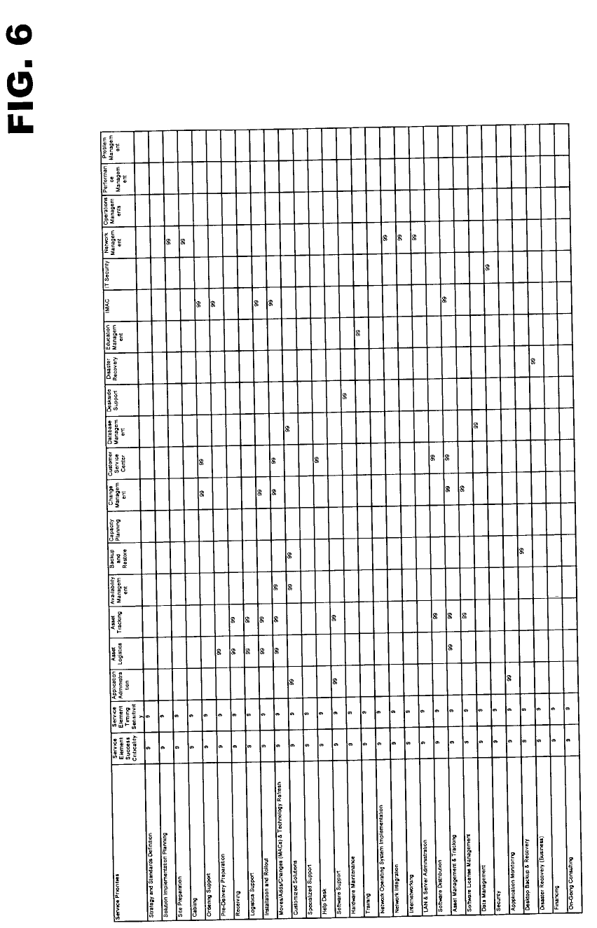

FIG. 6 shows a diagrammatic representation of another embodiment of a priority matrix for evaluating service elements accomplished by one or more technology component.

As can be seen in FIG. 6, the Criticality and Timing Values may be calculated from more complex variables than the simple 1 to 9 or 1 to 100 rankings of the above example. In addition, the Criticality and Timing Values may reflect more variables than criticality, health, call priority and answer priority. For example, the Criticality and Timing Values may include such complex variables as “application administration”, “asset logistics”, “asset tracking”, “availability management”, “backup and restore”, “capacity planning”, “change management”, “customer service center”, “database management”, “deskside support”, “disaster recovery”, “education management”, etc. Thus the Implementation Value algorithm may be more complex as the variables used in the Criticality and Timing Values become more complex. The variables used may also reflect other enabling components, such as enabling staff, enabling processes and enabling tools in addition to IT components or technology components.

For example, domain considerations may also be included in the algorithm. The Domain Variable describes issues associated with the customer environment, such as locations. The customer domain may span several buildings, cities, states, or even countries. This information is included as part of the deployment profile by recognizing where the effort must be executed in order to meet the customer's needs. For example, the service element “Upgrading Server” may be critical to a customer with a main office in Austin, Tex. and a small branch in Detroit, Mich. The Domain Variable may then be used to indicate that the service element “Upgrading Server” should be implemented first in the main Austin office before being implemented in the Detroit branch.

The algorithm may also consider the customer's organizational structures. The Organization Variable describes address entities within the customer's organization that may require prioritization in the deployment profile. To use the above customer as an example again, in addition to the main and branch offices, the customer also has dealers in Chicago, Ill., suppliers in Dublin, Ireland and a factory in Manila, Philippines. The customer may require that the service element “Upgrading Software” be deployed across all the facilities. Service-prioritizing matrix 122 then calculates Criticality and Timing values based on the Organization Variable, which indicates that the dealers receive the upgrade first as a test, then the administrative offices receive the upgrade, followed by the suppliers and finally the factory. The customer may additionally indicate, with the Domain Variable, that software should always be installed at facilities in the Philippines domain first, then the U.S. facilities, finally followed by the Irish facilities. Thus, the Criticality and Timing Values will be calculated based on more complex variable schemes.

The algorithm may also include a Staffing Variable. This Staffing Variable reflects the staff that is required to support the service element. Staffing may especially affect the Timing Value if the staffing variable indicates that one or more staff should be hired to support the service element. The Staffing Variable could also be used to reflect the level of training required to support the service element. The Staffing Variable might also be used to indicate when and if staff may be required to support the service element.

The algorithm may also include a Communications Variable. The Communications Variable indicates how the service-provisioner will communication with the customer. The Communications Variable may reflect language considerations (e.g., a customer has the U.S., Filipino, and Irish facilities so the “Upgrading Software” service element's Criticality and Timing values include a Communications Variable which reflects the need for slightly different program language in each of the foreign facilities). The Communications Variable may also indicate the potential of the existence of multiple communications tools within the customer's environment. The Communications Variable may also reflect that the customer may be transitioning to new communications tools.

Thus, the algorithm of the present invention is capable of calculating Criticality and Timing Values based on a plurality of variables. It will be appreciated that the present invention is not limited to the variables described above and other suitable variables influencing Criticality and Timing values are also within the scope of the invention.

In addition, the service elements for which Criticality and Timing Values may be calculated by service-prioritizing matrix 122 may also be fairly complex. For one example, a “Supporting Database” service element may comprise the building and maintenance of an entire database infrastructure necessary to support delivery of services to a customer account. The same “Supporting Database” service element also includes the design, development, deployment, maintenance and administration of customer databases. As another example, a “Controlling Availability” service element may comprise controlling the steady state operations of the customer's production environment to minimize the impact of changes and problems on the availability of the services being provided. The “Controlling Availability” service element therefore includes a large variety of subprocesses and activities.

Thus, the algorithm of the present invention is capable of calculating Criticality and Timing Values for complex, involved service elements and even for service elements comprising other service elements. It will be appreciated that the present invention is not limited to the service elements described above and other suitable service elements required by a given customer are also within the scope of the invention.

FIG. 7 is a block diagram of a data processing system in accordance with the present invention at 800. In one embodiment of the invention, data processing system 800 may be implemented as server 114 shown in FIG. 1.

Data processing system 800 may be a symmetric multiprocessors (SMP) system including a plurality of processors 802 and 804 connected to system bus 806. Alternatively, a single processor system may be employed. Memory controller/cache 808 may also be connected to system bus 806. Memory controller/cache 808 may provide an interface to local memory 809. I/O bus bridge 810 may also be connected to system bus 806 and may provide an interface to I/O bus 812. Memory controller/cache 808 and I/O bus bridge 810 may be integrated as depicted or may be separate components.

Peripheral component interconnect (PCI) bus bridge 814 connected to I/O bus 812 may provide an interface to PCI local bus 816. One or more modems may be connected to PCI bus 816. Typical PCI bus implementations will support four PCI expansion slots or add-in connectors. Modem 818 and network 820 may be connected to PCI local bus 816. This connection may be through add-in boards. In one embodiment of the invention, modem 818 and accompanying connections provide communications links to target devices such as network computers. For example, such target devices may be those described above at FIG. 1.

Additional PCI bus bridges 822 and 824 may provide interfaces for additional PCI buses 826 and 828. Additional modems or network adapters may be supported from PCI buses 826 and 828. In this manner, data processing system 800 may allow connections to multiple network computers. A memory-mapped graphics adapter 830 and hard disk 832 may also be connected to I/O bus 812 as depicted, either directly or indirectly.

The components depicted in FIG. 8 may be arranged as shown or in any suitable manner that allows data processing system 800 to function as desired. Additionally, other peripheral devices, such as optical disk drives and the like, may be used in addition to or in place of the components depicted.

FIG. 8 is a block diagram of a data processing system in accordance with the present invention at 900. Data processing system 900 may be client 104 in FIG. 1.

In one embodiment of the invention, data processing system 900 may be a stand-alone system configured to be bootable without relying on a network communication interface. Alternatively, data processing system 900 may also comprise one or more network communication interfaces. Data processing system 900 may also be a personal digital assistant (PDA) device. Data processing system may also take the form of a notebook computer or handheld computer. Alternatively, data processing system 900 may be a kiosk or Web appliance. The processes of the present invention may also be applied to a multiprocessor data processing system.

Data processing system 900 may employ a peripheral component interconnect (PCI) local bus architecture. Although the depicted example employs a PCI bus, other bus architectures such as Accelerated Graphics Port (AGP) and Industry Standard Architecture (ISA) may be used. Processor 902 and main memory 904 may be connected to PCI local bus 906 via PCI bridge 908. PCI bridge 908 may also include an integrated memory controller and cache memory for processor 902. Additional connections to PCI local bus 906 may be made through direct component interconnection or through add-in boards. In one embodiment of the invention, local area network (LAN) adapter 910, SCSI host bus adapter 912, and expansion bus interface 914 are connected to PCI local bus 906 by direct component connection. In contrast, audio adapter 916, graphics adapter 918 and audio/video adapter 919 are connected to PCI local bus 906 by add-in boards inserted into expansion slots. Expansion bus interface 914 may provide a connection for additional components such as, for example, a keyboard and mouse adapter 920, a modem 922 and additional memory 924. A small computer system interface (SCSI) host bus adapter 912 may provide a connection for additional components such as, for example, a hard disk drive 926, a tape drive 928, a CD-ROM drive 930 or a DVD 932. PCI local bus 906 may be any suitable local bus implementation. Typical PCI local bus implementations will support three or four PCI expansion slots or add-in connectors.

In one embodiment of the invention, a software program or application for selecting and managing test systems may run on processor 902. This software program may comprise, for example, components of blueprint service provisioning system 102. Instructions from system 102 may be located on storage devices such as, for example, hard disk drive 926. These instructions, applications and/or programs may be loaded into main memory 904 for execution by processor 902.

The components of system 900 depicted in FIG. 9 may be arranged as shown or in any suitable manner that allows data processing system 900 to function as desired. Other internal hardware or peripheral devices, such as flash ROM (or equivalent nonvolatile memory) or optical disk drives and the like, may be used in addition to or in place of the components depicted. For example, one embodiment of data processing system 900 may be configured with ROM and/or flash ROM in order to provide non-volatile memory for storing operating system files and/or user-generated data.

While the present invention has been described in the context of a fully functioning data processing system, it will be appreciated that the processes described may be distributed in any other suitable context. For example, the processes described may take the form of a computer readable medium of instructions. The present invention applies equally regardless of the type of signal bearing media actually used to carry out the distribution. Examples of computer readable media include recordable-type medium, such as a floppy disk, a hard disk drive, a RAM, CD-ROMs, DVD-ROMS, and transmission-type media, such as digital and analog communications links, wired or wireless communications links using transmission forms such as, for example, radio frequency and light wave transmissions. The computer readable media may take the form of coded formats that are decoded for actual use in a particular data processing system.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

1. A method of prioritizing a business process based on enabling technological components, comprising:
determining a plurality of service elements to be delivered during the business process;
determining a criticality value for a first service element of the business process;
determining a timing value for the first service element of the business process;
calculating a first implementation value based on the criticality value and the timing value; and
ranking the first service element in a hierarchy based on the first implementation value.

2. The method of claim 1, further comprising:
determining an additional service element of the business process.

3. The method of claim 2, further comprising:
determining an additional criticality value for the additional service element of the business process; and
determining an additional timing value for the additional service element of the business process.

4. The method of claim 3, further comprising:
calculating an additional implementation value based on the additional criticality value and the additional timing value.

5. The method of claim 4, further comprising:
ranking the additional service element in the hierarchy based on the additional implementation value.

6. The method of claim 1 further comprising:
determining if the technology component related to a given service element is adequate for delivering the given service element.

7. The method of claim 1 further comprising:
assigning a nonessential value to a service element that is not part of the business process.

8. The method of claim 1 wherein the timing value indicates the current health of the service element.

9. The method of claim 1 wherein the timing value is calculated using at least one variable selected from the group consisting of:
a call priority variable, an answer priority variable, a domain variable, an organization variable, a staffing variable and a communications variable.

10. The method of claim 1 wherein the criticality value is calculated using at least one variable selected from the group consisting of:
a call priority variable, an answer priority variable, a domain variable, an organization variable, a staffing variable and a communications variable.

11. Computer program product for prioritizing a business process based on enabling technological components, comprising:
means for determining a plurality of service elements to be delivered during the business process;
means for determining a criticality value for a first service element of the business process;
means for determining a timing value for the first service element of the business process;
means for calculating a first implementation value based on the criticality value and the timing value; and
means for ranking the first service element in a hierarchy based on the first implementation value.

12. The product of claim 11, further comprising:
means for determining an additional service element of the business process.

13. The product of claim 12, further comprising:
means for determining an additional criticality value for the additional service element of the business process; and
means for determining an additional timing value for the additional service element of the business process.

14. The product of claim 13, further comprising:
means for calculating an additional implementation value based on the additional criticality value and the additional timing value.

15. The product of claim 14, further comprising:
means for ranking the additional service element in the hierarchy based on the additional implementation value.

16. The product of claim 11 further comprising:
means for determining if the technology component related to a given service element is adequate for delivering the given service element.

17. The product of claim 11 further comprising:
means for assigning a nonessential value to a service element that is not part of the business process.

18. The product of claim 11 further comprising:
means for calculating the timing value based on at least one variable selected from the group consisting of:
a call priority variable, an answer priority variable, a domain variable, an organization variable, a staffing variable and a communications variable.

19. The product of claim 11 further comprising:
means for calculating the criticality value based on at least one variable selected from the group consisting of:
a call priority variable, an answer priority variable, a domain variable, an organization variable, a staffing variable and a communications variable.

20. A system for prioritizing a business process based on enabling technological components, comprising:
means for determining a plurality of service elements to be delivered during the business process;
means for determining a criticality value for a first service element of the business process;
means for determining a timing value for the first service element of the business process;
means for calculating a first implementation value based on the criticality value and the timing value; and
means for ranking the first service element in a hierarchy based on the first implementation value.
